(19) United States
(12) Patent Application Publication
(10) Pub. No.: US 2026/0211398 A1
(43) Pub. Date: Jul. 23, 2026

(54) MOLD MANUFACTURING ASSISTANCE SYSTEM, MOLD MANUFACTURING ASSISTANCE METHOD, AND METHOD FOR GENERATING TRAINING DATASET

(71) Applicant: KABUSHIKI KAISHA KOBE SEIKO SHO (KOBE STEEL, LTD.), Hyogo (JP)

(72) Inventors: Ryohei IHARA, Kobe-shi, Hyogo (JP); Takashi WADA, Kobe-shi, Hyogo (JP); Shinichi YAMAMOTO, Kobe-shi, Hyogo (JP)

(73) Assignee: KABUSHIKI KAISHA KOBE SEIKO SHO (KOBE STEEL, LTD.), Hyogo (JP)

(21) Appl. No.: 19/157,885

(22) PCT Filed: Dec. 26, 2023
(86) PCT No.: PCT/JP2023/046640

§ 371 Date: Aug. 19, 2025

(30) Foreign Application Priority Data
Mar. 30, 2023 (JP) 2023-054608

(51) Int. Cl. G05B 19/4097

(52) U.S. Cl. CPC G05B 19/4097; G05B 2219/33034; G05B 2219/35012

(57) ABSTRACT

A mold manufacturing assistance system includes: an acquisition unit that acquires mold actual shape data representing an actual shape of a mold and molded product difference data representing a difference between an actual shape and a target shape of a molded product molded by the mold; and an estimation unit that estimates mold target shape data representing a target shape of the mold from the mold actual shape data and the molded product difference data by using a trained model generated in advance by machine learning, with training mold shape data and training molded product difference data as input data and with training mold target shape data as teacher data.

### TECHNICAL FIELD

The present invention relates to a mold manufacturing assistance system, a mold manufacturing assistance method, and a method for generating a training dataset.

### BACKGROUND ART

Patent Document 1 discloses a technique for obtaining expected shape data of a mold by so-called computer aided engineering (CAE).

PRIOR ART DOCUMENT

### Patent Document

Patent Document 1: JP 2012-119010 A

### SUMMARY OF THE INVENTION

### Problems to be Solved by the Invention

In the conventional technique as described above, the number of times of mold shape correction may increase due to insufficient expected accuracy and the like. In particular, in recent years, it has been difficult to satisfy dimensional accuracy of a molded product due to spring back and the like after molding in addition to problems of cracking and wrinkles due to high strength of a material, and the number of times of mold shape correction tends to increase more and more.

The present invention has been made in view of the above problems, and a main object thereof is to provide a mold manufacturing assistance system, a mold manufacturing assistance method, and a method for generating a training dataset that enable reduction in the number of times of mold shape correction.

### Solutions to the Problems

In order to solve the above problem, a mold manufacturing assistance system according to one aspect of the present invention includes: an acquisition unit that acquires mold actual shape data representing an actual shape of a mold and molded product difference data representing a difference between an actual shape and a target shape of a molded product molded by the mold; and an estimation unit that estimates mold target shape data representing a target shape of the mold from the mold actual shape data and the molded product difference data by using a trained model generated in advance by machine learning, with training mold shape data and training molded product difference data as input data and with training mold target shape data as teacher data. This makes it possible to reduce the number of times of mold shape correction.

In the above aspect, a conversion unit may be further included that converts original data representing the actual shape of the mold into the mold actual shape data to be input to the trained model. This makes it possible to obtain mold actual shape data from the original data.

In the above aspect, there may be further included a CAM unit that converts the mold target shape data into NC data; and a machine tool that corrects the actual shape of the mold based on the NC data. This makes it possible to correct the actual shape of the mold based on the mold target shape data estimated by the trained model.

In the above aspect, a shape measuring instrument may be further included that measures an actual shape of a molded product molded by the mold that has been corrected by the machine tool. This makes it possible to measure the actual shape of the molded product molded by the corrected mold.

In the above aspect, a subtraction unit may be further included that calculates after-correction difference data representing a difference between the actual shape of the molded product measured by the shape measuring instrument and the target shape. This makes it possible to calculate the difference between the actual shape of the molded product molded by the corrected mold and the target shape.

In the above aspect, the estimation unit may estimate new mold target shape data using the mold target shape data as new mold actual shape data and using the after-correction difference data as new molded product difference data. This makes it possible to repeat estimation of the mold target shape data.

In the above aspect, there may be further included a display unit that displays the mold target shape data estimated by the trained model; and a reception unit that receives decision of the target shape of the mold by a user. This allows the user to decide the target shape of the mold by watching the displayed mold target shape data.

In the above aspect, a training unit may be further included that performs retraining of the trained model by using the mold target shape data estimated by the trained model and molded product actual shape data representing the actual shape of the molded product measured by the shape measuring instrument. This makes it possible to further improve estimation accuracy of the trained model.

A mold manufacturing assistance method according to another aspect of the present invention includes: acquiring mold actual shape data representing an actual shape of a mold and molded product difference data representing a difference between an actual shape and a target shape of a molded product molded by the mold; and estimating mold target shape data representing a target shape of the mold from the mold actual shape data and the molded product difference data by using a trained model generated in advance by machine learning, with training mold shape data and training molded product difference data as input data and with training mold target shape data as teacher data. This makes it possible to reduce the number of times of mold shape correction.

A method for generating a training dataset according to a further aspect of the present invention includes: preparing a plurality of pieces of mold shape data and a plurality of pieces of molded product shape data corresponding to the plurality of pieces of mold shape data; extracting first and second mold shape data from the plurality of pieces of mold shape data; extracting first and second molded product shape data corresponding to the first and second mold shape data from the plurality of pieces of molded product shape data; and setting the first mold shape data as training mold shape data, setting a difference between the first and second molded product shape data as training molded product difference data, and setting the second mold shape data as training mold target shape data. This makes it possible to generate a trained model by machine learning using the training mold shape data and the training molded product difference data as input data and using the training mold target shape data as teacher data, so that it is possible to estimate the mold target shape without complicated user's GUI manipulation or the like.

A mold manufacturing assistance system according to a still further aspect of the present invention includes: an acquisition unit that acquires mold shape data representing a shape of a mold; and an estimation unit that estimates molded product predicted shape data representing a predicted shape of a molded product from the mold shape data by using a trained model generated in advance by machine learning, with training mold shape data as input data and training molded product shape data as teacher data. This makes it possible to reduce the number of times of mold shape correction.

In the above aspect, a display unit may be further included that displays the mold shape data and the molded product predicted shape data. This allows the user to compare the mold shape data with the molded product predicted shape data.

In the above aspect, the display unit may further display molded product target shape data representing a target shape of the molded product. This allows the user to compare the molded product predicted shape data with the molded product target shape data.

In the above aspect, a reception unit may be further included that receives correction of the mold shape data by a user, in which the estimation unit may estimate new molded product predicted shape data from the corrected mold shape data, and the display unit may display the new molded product predicted shape data. This makes it possible to estimate and display new molded product shape data from the mold shape data corrected by the user.

A mold manufacturing assistance method according to a still further aspect of the present invention includes: acquiring mold shape data representing a shape of a mold; and estimating molded product predicted shape data representing a predicted shape of a molded product from the mold shape data by using a trained model generated in advance by machine learning, with training mold shape data as input data and training molded product shape data as teacher data. This makes it possible to reduce the number of times of mold shape correction.

### BRIEF DESCRIPTION OF THE DRAWINGS

FIG. 1 is a diagram showing an example of a mold manufacturing assistance system according to a first embodiment.

FIG. 2 is a diagram for describing estimation of mold target shape data.

FIG. 3 is a diagram showing an example of an assistance device and a GUI terminal.

FIG. 4 is a diagram showing an example of a mold manufacturing assistance method.

FIG. 5 is a diagram for describing creation of a training dataset.

FIG. 6 is a diagram for describing creation of a training dataset.

FIG. 7 is a diagram showing an example of a mold manufacturing assistance system according to a second embodiment.

FIG. 8 is a diagram showing an example of a mold manufacturing assistance system according to a third embodiment.

FIG. 9 is a diagram showing an example of a mold manufacturing assistance system according to a fourth embodiment.

FIG. 10 is a diagram for describing estimation of molded product shape data.

FIG. 11A is a diagram showing a display example of the GUI terminal.

FIG. 11B is a diagram showing a display example of the GUI terminal.

FIG. 11C is a diagram showing a display example of the GUI terminal.

FIG. 11D is a diagram showing a display example of the GUI terminal.

FIG. 12 is a diagram showing an example of a mold manufacturing assistance method.

### DETAILED DESCRIPTION

In the following, embodiments of the present invention will be described in detail with reference to the drawings. Note that, in the present specification and each drawing, elements similar to those described above with respect to the previously described drawings are denoted by the same reference numerals, and detailed description thereof may be appropriately omitted.

Functions of the elements disclosed in the present specification can be performed using circuitry or processing circuitry including a general purpose processor, a special purpose processor, an integrated circuit, an application specific integrated circuit (ASIC), a conventional circuit, and/or combinations thereof configured to or programmed to perform the disclosed functions. The processor is considered a processing circuit or a circuit because it includes a transistor and other circuits. In the present disclosure, a circuit, a unit, or means may be hardware that executes the recited functions or may be hardware programmed to execute the recited functions, The hardware may be the hardware disclosed in the present specification or may be other known hardware that is programmed or configured to execute the recited functions. In a case where hardware is a processor considered as a kind of circuit, the circuit, the means, or the unit is a combination of hardware and software, and the software is used for configuring the hardware and/or the processor.

### First Embodiment

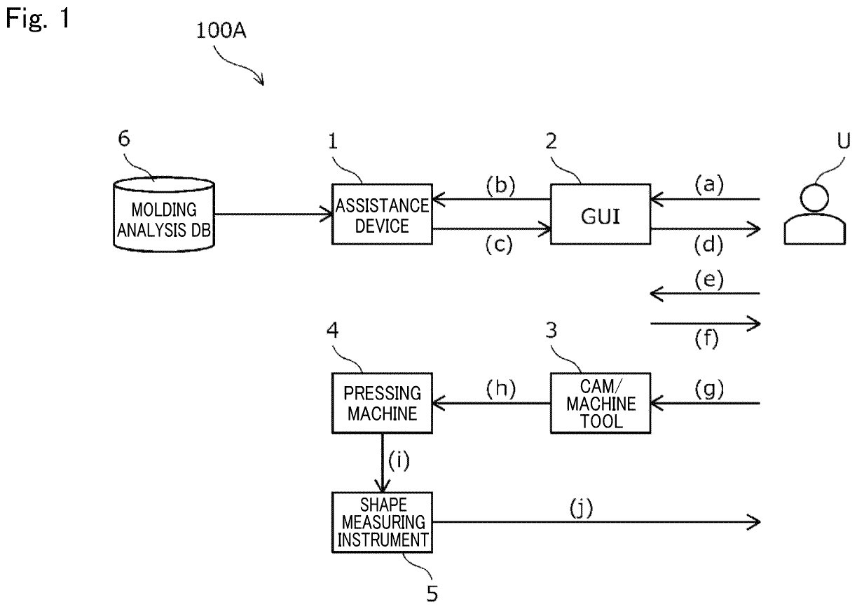

FIG. 1 is a diagram showing a configuration example of a mold manufacturing assistance system 100A according to a first embodiment. The mold manufacturing assistance system 100A is a system for assisting manufacturing of a mold for use in press molding.

The mold manufacturing assistance system 100A includes an assistance device 1, a graphical user interface (GUI) terminal 2, a CAM/machine tool 3, a pressing machine 4, a shape measuring instrument 5, and a molding analysis database (DB) 6.

The assistance device 1 is provided with a computer including a CPU, a RAM, a ROM, a nonvolatile memory, an input/output interface, and the like. The GUI terminal 2 is a terminal that provides a GUI to a user U, and includes a computer similarly to the assistance device 1.

The CPU executes information processing according to a program loaded from a ROM or a nonvolatile memory into a RAM. The program may be supplied via an information storage medium or may be supplied via a communication network.

In the present embodiment, the assistance device 1 and the GUI terminal 2 have a relationship of a server and a client. Not limited thereto, the assistance device 1 and the GUI terminal 2 may be integrated. In other words, function of the assistance device 1 and function of the GUI terminal 2 may be realized by one device.

The CAM/machine tool 3 includes a CAM unit that generates NC data and a machine tool that produces a mold based on the NC data.

The pressing machine 4 produces a molded product by press molding using a mold.

The shape measuring instrument 5 measures a shape of the produced molded product. The shape measuring instrument 5 is, for example, a 3D scanner or a contact type or non-contact type displacement sensor.

The molding analysis DB 6 is a database that stores data of a mold and data of a molded product produced in the past. The mold data and the molded product data include not only actual shape data obtained by testing and measurement but also data obtained by CAE.

In the following, steps (a) to (j) shown in FIG. 1 will be described.

(a) The user U inputs, to the GUI terminal 2, original data representing an actual shape of a mold, original data representing an actual shape of a molded product molded by the mold, and original data representing a target shape of the molded product. The original data is, for example, CAD data or STL data, or the like.

(b) The GUI terminal 2 generates data to be input to a trained model based on the original data, and outputs the data to the assistance device 1. Specifically, the GUI terminal 2 converts the original data representing the actual shape of the mold into mold actual shape data to be input to the trained model. The GUI terminal 2 calculates molded product difference data representing a difference between the actual shape and the target shape of the molded product.

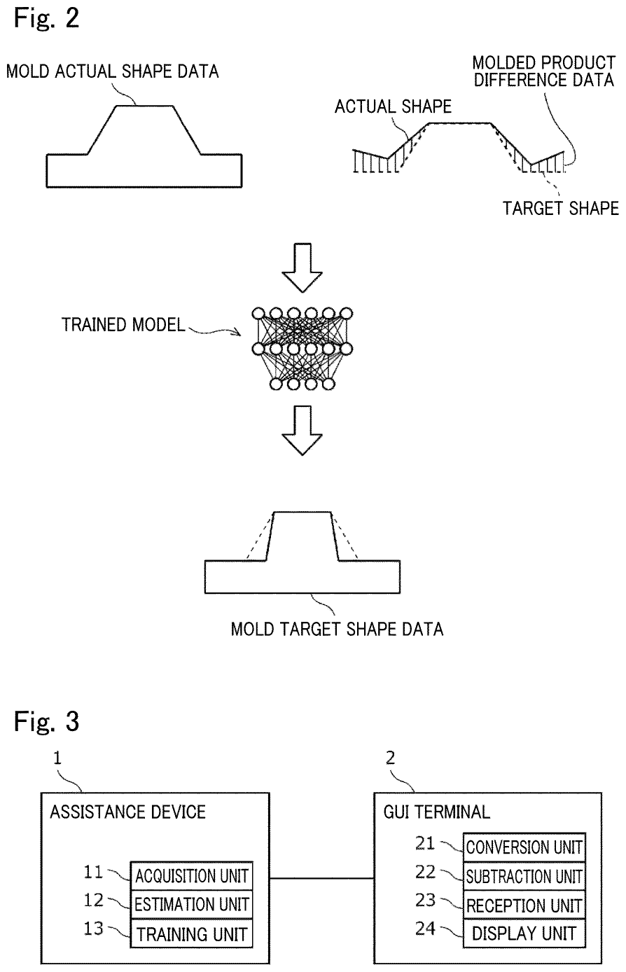

(c) The assistance device 1 estimates mold target shape data representing a target shape of a mold from the mold actual shape data and the molded product difference data acquired from the GUI terminal 2 using the trained model (see FIG. 2), and outputs the data to the GUI terminal 2.

The trained model is a model generated in advance by machine learning using training mold shape data and training molded product difference data as input data and using training mold target shape data as teacher data. Generation of training data will be described later. The trained model is, for example, a regression model such as a neural network or a Gaussian process.

(d) The GUI terminal 2 displays the mold target shape data output from the assistance device 1. The user U checks the mold target shape data displayed on the GUI terminal 2 and determines whether or not to adopt the mold target shape data. (e) When receiving the decision of the mold target shape by the user, (f) the GUI terminal 2 outputs the mold target shape data.

(g) The user U inputs the mold target shape data to the CAM/machine tool 3. (h) The CAM/machine tool 3 converts the mold target shape data into the NC data, and corrects the actual shape of the mold based on the converted NC data. (i) The pressing machine 4 molds a molded product with the corrected mold.

(j) The shape measuring instrument 5 measures an actual shape of the molded product molded by the corrected mold. Thereafter, the steps (a) to (j) are performed again using the mold target shape data as new mold actual shape data and using after-correction difference data representing a difference between the measured actual shape of the molded product and the target shape as new molded product difference data. Note that data obtained by measuring an actual mold may be used as the mold actual shape data.

The steps (a) to (j) described above are repeated until there is no difference between the actual shape and the target shape of the molded product.

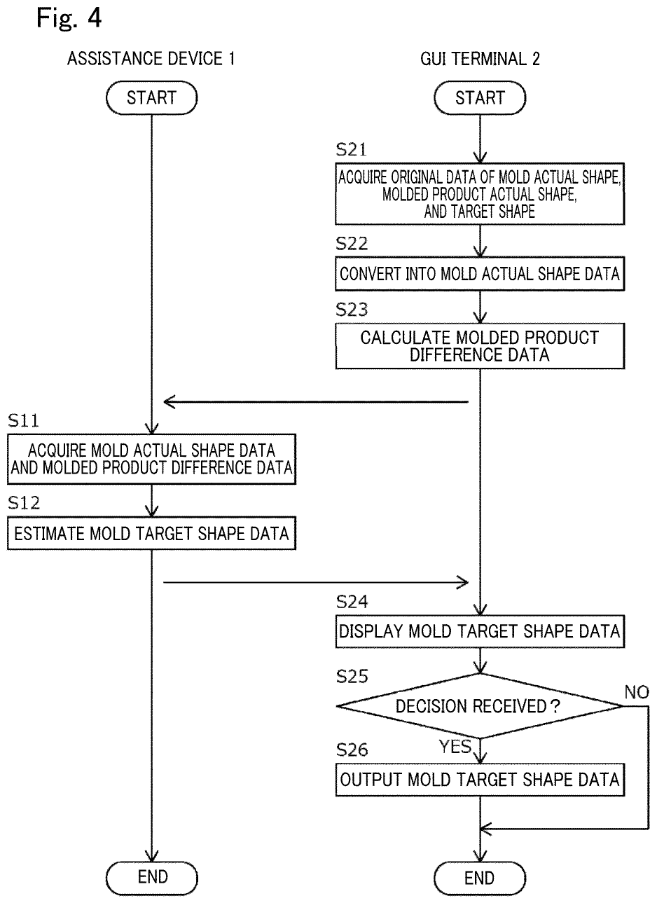

FIG. 3 is a block diagram showing a configuration example of the assistance device 1 and the GUI terminal 2. The assistance device 1 includes an acquisition unit 11, an estimation unit 12, and a training unit 13. These functional units are implemented by the CPU of the assistance device 1 executing information processing according to the program loaded from the ROM or the nonvolatile memory into the RAM.

The GUI terminal 2 includes a conversion unit 21 and a subtraction unit 22. These functional units are implemented by the CPU of the GUI terminal 2 executing information processing according to the program loaded from the ROM or the nonvolatile memory into the RAM.

In addition, the GUI terminal 2 includes a reception unit 23 and a display unit 24. The reception unit 23 is, for example, a keyboard, a mouse, or the like, and receives manipulation by the user U. The display unit 24 is, for example, a liquid crystal display or the like.

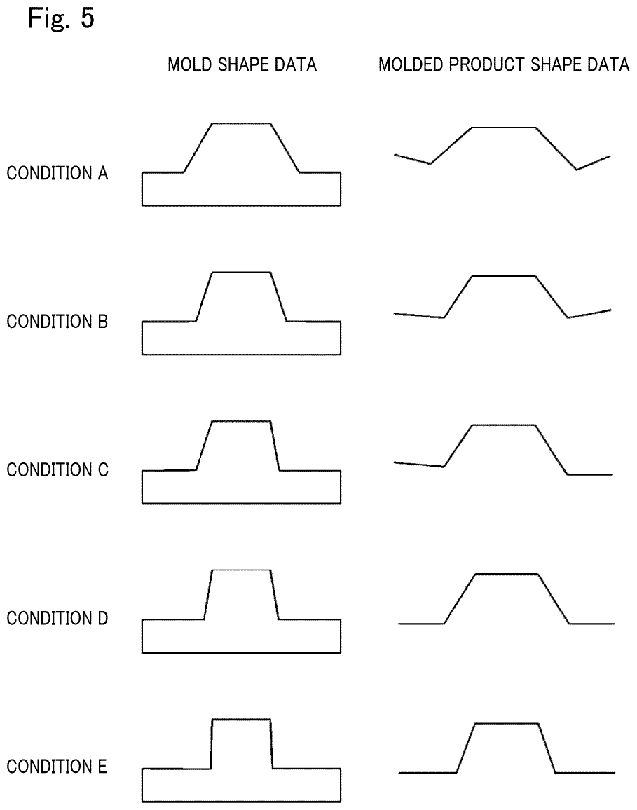

FIG. 4 is a flowchart showing an exemplary procedure of a mold manufacturing assistance method implemented in the mold manufacturing assistance system 100A. Each of the assistance device I and the GUI terminal 2 executes information processing shown in the drawing according to a program.

First, the GUI terminal 2 acquires the original data representing an actual shape of a mold, the original data representing an actual shape of a molded product molded by the mold, and original data representing a target shape of the molded product (S21, corresponding to step (a) described above).

Next, the GUI terminal 2 converts the original data representing the actual shape of the mold into the mold actual shape data to be input to the trained model (S22, processing as the conversion unit 21, corresponding to step (b) described above). The mold actual shape data is represented by, for example, point cloud data such as CAD data or STL data. In a case where the number of measurement points of the STL data is large, dimension reduction by feature value extraction may be performed.

Next, the GUI terminal 2 calculates the molded product difference data representing a difference between the actual shape and the target shape of the molded product (S23, processing as the subtraction unit 22, corresponding to the step (b) described above).

The assistance device 1 acquires the mold actual shape data and the molded product difference data from the GUI terminal 2 (S11, processing as the acquisition unit 11).

Next, the assistance device 1 estimates the mold target shape data from the mold actual shape data and the molded product difference data using the trained model (S12, processing as the estimation unit 12, corresponding to the step (c) described above).

The GUI terminal 2 displays the mold target shape data estimated by the trained model in the assistance device 1 on the display unit 24 (S24, corresponding to step (d) described above).

Next, when the reception unit 23 receives the decision of the mold target shape by the user (S25: YES), the GUI terminal 2 outputs the mold target shape data (S26, corresponding to the steps (e) and (f) described above).

As described above, the mold target shape data is used to correct the actual shape of the mold by the CAM/machine tool 3, and a shape of the molded product molded by the corrected mold is measured by the shape measuring instrument 5 (corresponding to the steps (g) to (j) described above).

The GUI terminal 2 calculates the after-correction difference data representing a difference between the actual shape of the molded product measured by the shape measuring instrument 5 and the target shape (processing as the subtraction unit 22).

The assistance device 1 estimates new mold target shape data from the GUI terminal 2 using the mold target shape data as new mold actual shape data and using the after-correction difference data as new molded product difference data (processing as the estimation unit 12).

According to the present embodiment, it is possible to quickly obtain an appropriate mold target shape by a trained model without depending on experience, know-how, intuition, or the like of an expert, and thus, it is possible to reduce the number of times of mold shape correction.

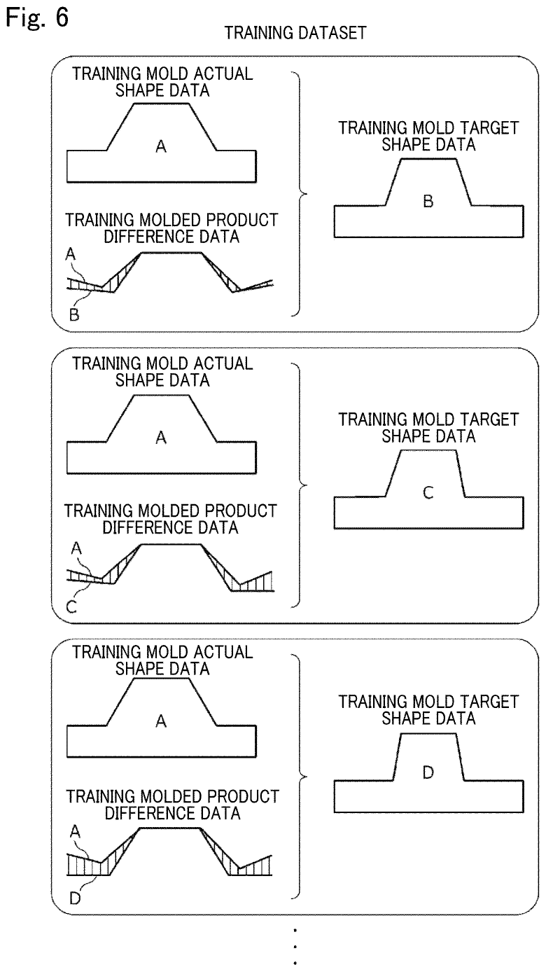

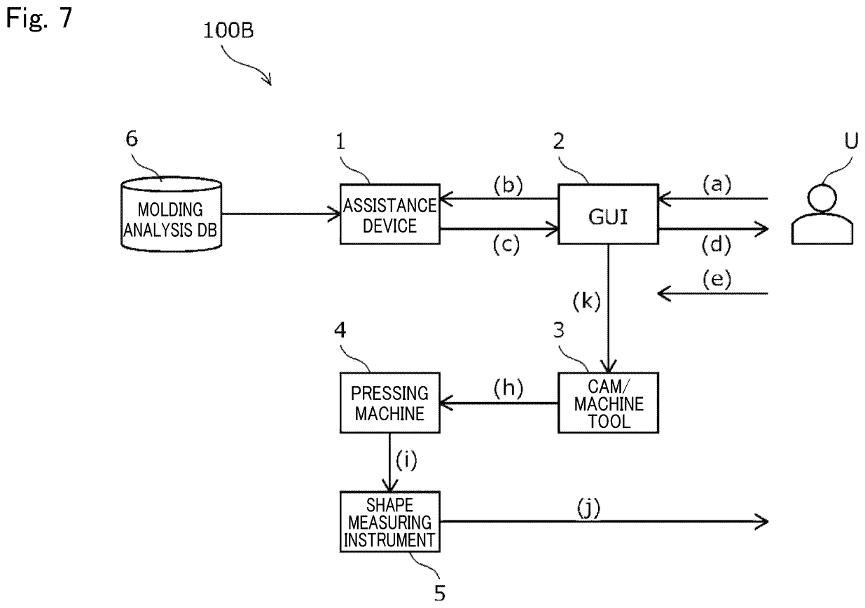

FIGS. 5 and 6 are diagrams for describing creation of a training dataset. The creation of the training dataset and creation of a trained model using the training dataset are performed by the training unit 13 of the assistance device 1.

As illustrated in FIG. 5, a plurality of pieces of mold shape data and a plurality of pieces of molded product shape data corresponding thereto are prepared in the molding analysis DB 6. In other words, the plurality of sets of mold shape data representing a shape of a mold and the molded product shape data representing a shape of a molded product molded by the mold are prepared. Conditions A to E refer to shapes of molds.

As illustrated in FIG. 6, first and second mold shape data and first and second molded product shape data corresponding thereto are extracted from the molding analysis DB 6, and a training dataset is created with the first mold shape data as training mold shape data, a difference between the first and second molded product shape data as training molded product difference data, and the second mold shape data as training mold target shape data.

For example, in a case where mold shape data and molded product shape data of the condition A and mold shape data and molded product shape data of the condition B are extracted, a training dataset based on a condition A-B is created with the mold shape data of the condition A as the training mold shape data, a difference between the molded product shape data of the condition A and the molded product shape data of the condition B as the training molded product difference data, and the mold shape data of the condition B as the training mold target shape data.

Similarly, training datasets based on a condition A-C, a condition A-D. and a condition A-E can also be created, and further, training datasets based on a condition B-A, a condition B-C, . . . , a condition C-A, a condition C-B, . . . , a condition D-A, a condition D-B, . . . , a condition E-A, a condition E-B, . . . can also be created. By changing a combination of two conditions to be extracted in this manner, it is possible to create a large number of training datasets.

### Second Embodiment

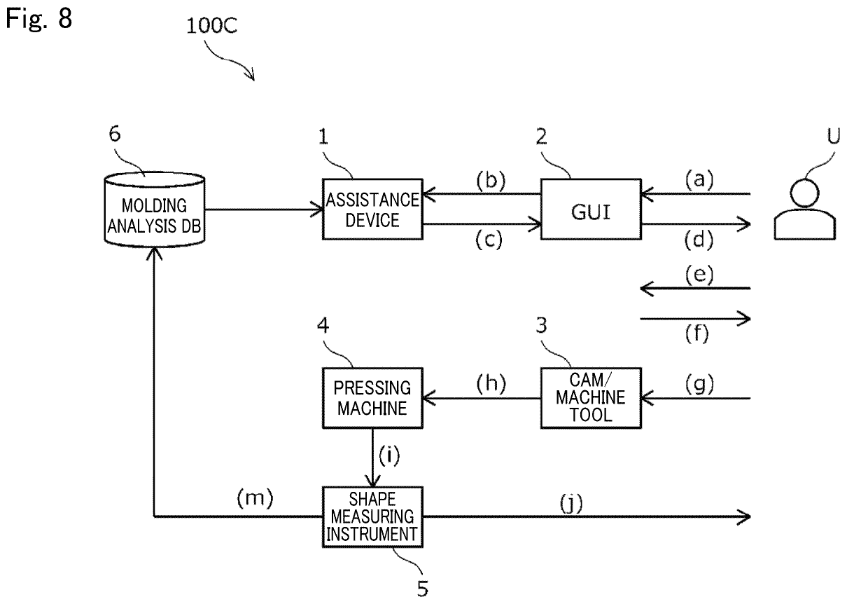

FIG. 7 is a diagram showing an example of a mold manufacturing assistance system 100B according to a second embodiment. In the present embodiment, (e) when the GUI terminal 2 receives the decision of the mold target shape, (k) the mold target shape data is output from the GUI terminal 2 directly to the CAM/machine tool 3. This makes it possible to realize automation of mold correction and reduce a burden on the user U.

### Third Embodiment

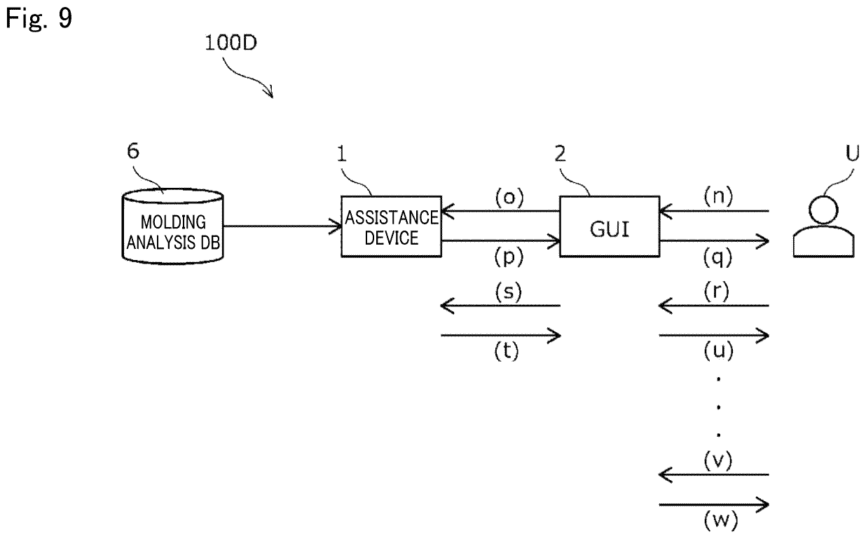

FIG. 8 is a diagram showing an example of a mold manufacturing assistance system 100C according to a third embodiment. In the present embodiment, (j) when the shape measuring instrument 5 measures an actual shape of the molded product, (m) the mold shape data and the molded product shape data are registered in the molding analysis DB 6, and the trained model is retrained by the training unit 13 of the assistance device 1. This makes it possible to improve estimation accuracy.

Although the present embodiment is obtained by adding the step (m) to the first embodiment, the present invention is not limited thereto, and the step (m) may be added to the above second embodiment.

### Fourth Embodiment

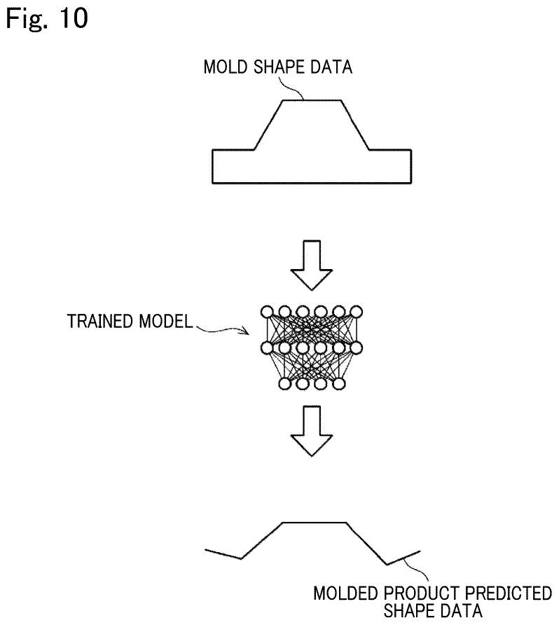

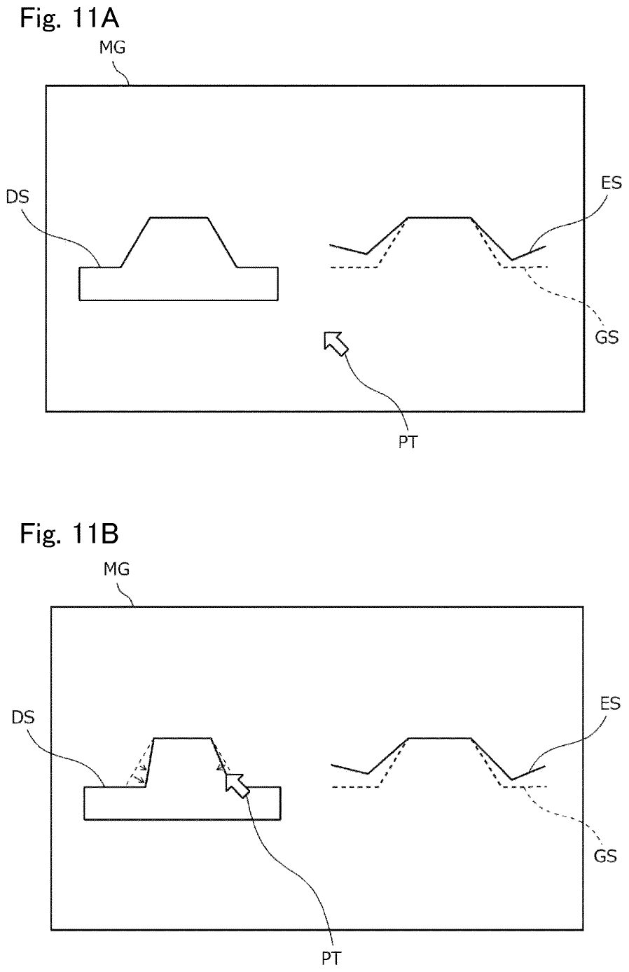

FIG. 9 is a diagram showing an example of a mold manufacturing assistance system 100D according to a fourth embodiment. In the present embodiment, it is realized that a mold shape is decided in an interactive manner using a trained model (see FIG. 10) that outputs molded product predicted shape data representing a predicted shape of a molded product when the mold shape data representing a shape of a mold is input (also referred to as “surrogate model”).

In the following, steps (n) to (w) shown in FIG. 9 will be described.

(n) The user U inputs the original data representing the shape of the mold and the original data representing the target shape of the molded product to the GUI terminal 2. The original data is, for example, CAD data or STL data, or the like.

(o) The GUI terminal 2 generates data to be input to a trained model based on the original data, and outputs the data to the assistance device 1. Specifically, the GUI terminal 2 converts the original data representing the shape of the mold into the mold shape data to be input to the trained model.

(p) The assistance device 1 estimates the molded product predicted shape data representing a predicted shape of a molded product from the mold shape data acquired from the GUI terminal 2 using the trained model (see FIG. 10), and outputs the molded product predicted shape data to the GUI terminal 2.

(q) The GUI terminal 2 displays the molded product predicted shape data output from the assistance device 1. Here, the mold shape data and the molded product predicted shape data are displayed side by side. The molded product predicted shape data and molded product target shape data representing a target shape of a molded product are also displayed in an overlapping manner.

(r) The user U inputs correction of the mold shape data while checking the mold shape data, the molded product predicted shape data, and the molded product target shape data displayed on the GUI terminal 2. The GUI terminal 2 receives the correction of the mold shape data by the user.

(s) The GUI terminal 2 outputs the corrected mold shape data to the assistance device 1. (t) The assistance device 1 estimates new molded product predicted shape data from the corrected mold shape data using the trained model, and outputs the new molded product predicted shape data to the GUI terminal 2.

(u) The GUI terminal 2 displays the new molded product predicted shape data output from the assistance device 1. Here, similarly to the step (q) described above, the GUI terminal 2 displays the mold shape data, the molded product predicted shape data, and the molded product target shape data.

The user U repeats the correction of the mold shape data until a difference between a molded product predicted shape and a molded product target shape disappears or an error decreases to an allowable range, and the steps (r) to (u) described above are repeated accordingly.

(v) When no difference appears between the molded product predicted shape and the molded product target shape, the user U inputs decision of the mold shape data. (w) When receiving the decision of the mold shape data by the user, the GUI terminal 2 outputs the mold shape data.

The output mold shape data is used for producing a mold by the CAM/machine tool 3, and the produced mold is used for press molding by the pressing machine 4 (see FIG. 1 and the like).

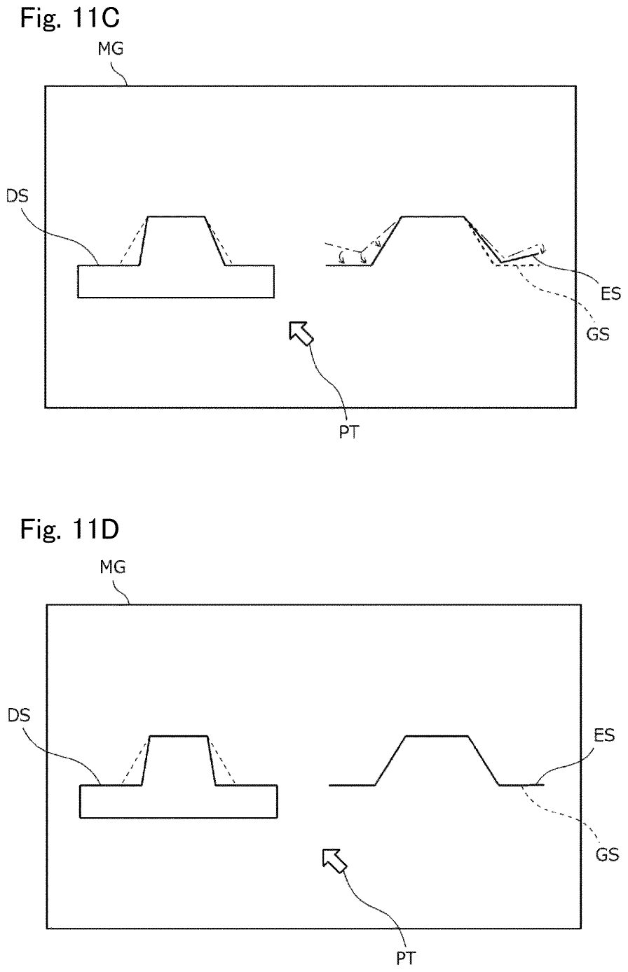

FIGS. 11A to 11D are diagrams showing display examples of the GUI terminal 2.

As illustrated in FIG. 11A, a mold shape object DS based on the mold shape data and a molded product predicted shape object ES based on the molded product predicted shape data are displayed side by side on a screen MG of the GUI terminal 2 (corresponding to the step (q) described above). The molded product predicted shape object ES and a molded product target shape object GS based on the molded product target shape data are displayed in an overlapping manner.

By displaying the mold shape object DS and the molded product predicted shape object ES side by side, it is possible to visually grasp what kind of shape of a molded product is predicted by a mold. Also by displaying the molded product predicted shape object ES and the molded product target shape object GS in an overlapping manner, it is possible to visually grasp a difference between a predicted shape and a target shape of a molded product.

As illustrated in FIG. 11B, the user U corrects the shape of the mold shape object DS while watching the screen MG (corresponding to the step of (r)). The shape of the mold shape object DS is corrected, for example, by dragging a contour with a pointer PT. By correcting the shape of the mold shape object DS, the mold shape data on which the mold shape object DS is based is corrected.

As illustrated in FIG. 11C, when the shape of the mold shape object DS is corrected, the shape of the molded product predicted shape object ES changes accordingly (corresponding to the steps (t) and (u) described above). In other words, when the mold shape data is corrected, new molded product predicted shape data is estimated from the corrected mold shape data, whereby the shape of the molded product predicted shape object ES changes.

As illustrated in FIG. 11D, the user U repeats the correction of the shape of the mold shape object DS while watching the screen MG until the difference between the molded product predicted shape object ES and the molded product target shape object GS disappears or the error decreases to the allowable range. Finally, when the shape of the mold shape object DS is decided, mold shape data corresponding to the mold shape object DS is output.

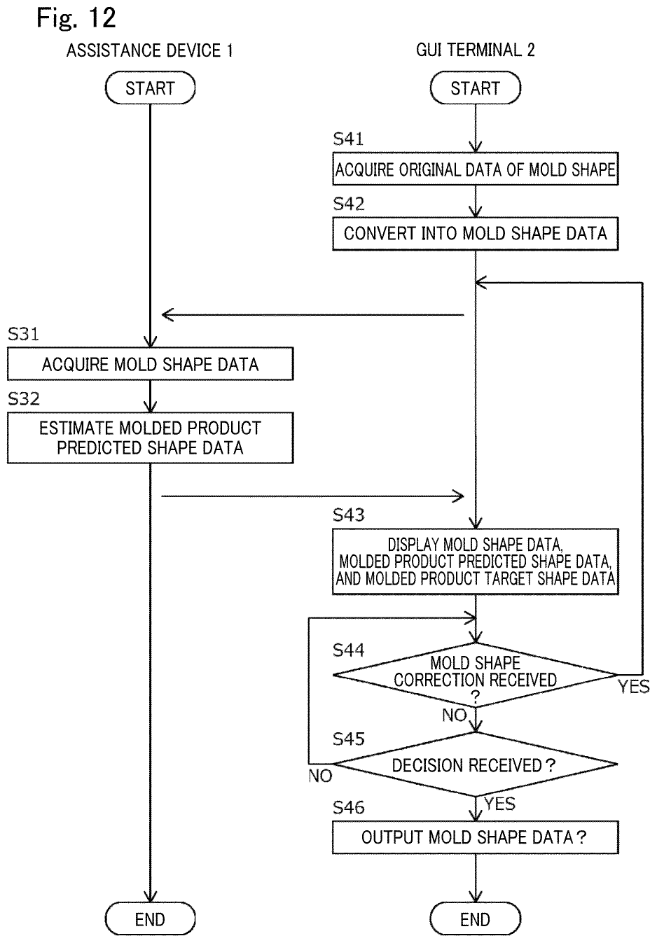

FIG. 12 is a flowchart showing an exemplary procedure of a mold manufacturing assistance method implemented in the mold manufacturing assistance system 100D. Each of the assistance device 1 and the GUI terminal 2 executes information processing shown in the drawing according to a program.

First, the GUI terminal 2 acquires the original data representing the mold shape (S41, corresponding to the step (n) described above), and converts the original data into the mold shape data to be input to the trained model (S42, processing as the conversion unit 21, corresponding to the step (o) described above).

The assistance device 1 acquires the mold shape data from the GUI terminal 2 (S31, processing as the acquisition unit 11), and estimates the molded product predicted shape data from the mold shape data using the trained model (S32, processing as the estimation unit 12, corresponding to the step (p) described above).

The GUI terminal 2 displays the mold shape data, the molded product predicted shape data estimated by the trained model in the assistance device 1, and the molded product target shape data on the display unit 24 (S43, corresponding to the step (q) described above, see FIG. 11A).

When receiving the correction of the mold shape data by the user at the reception unit 23 (S44: YES), the GUI terminal 2 outputs the corrected mold shape data to the assistance device I (corresponds to the steps (r) and(s) described above, see FIG. 11B).

When acquiring the corrected mold shape data from the GUI terminal 2 (S31), the assistance device 1 estimates new molded product predicted shape data from the corrected mold shape data using the trained model (S32, corresponding to the step (t) described above).

The GUI terminal 2 displays the new molded product predicted shape data estimated by the trained model in the assistance device I instead of the molded product target shape data displayed so far (S43, corresponding to the step (u) described above, see FIG. 11C).

The foregoing processing is repeated until the correction of the mold shape data by the user U is completed.

Thereafter, when receiving the decision of the mold shape by the user at the reception unit 23 (S45: YES), the GUI terminal 2 outputs the mold shape data (S46, corresponding to the steps (v) and (w) described above).

According to the present embodiment, it is possible to decide a mold shape for achieving a molded product target shape in an interactive manner without depending on experience, know-how, intuition, or the like of an expert, and thus, it is possible to reduce the number of times of mold shape correction.

Although the embodiments of the present invention have been described in the foregoing, the present invention is not limited to the embodiments described above, and it is a matter of course that various modifications can be made by those skilled in the art.

The present disclosure may include the following aspects.

### (First Aspect)

A mold manufacturing assistance system including:
an acquisition unit that acquires mold actual shape data representing an actual shape of a mold and molded product difference data representing a difference between an actual shape and a target shape of a molded product molded by the mold; and
an estimation unit that estimates mold target shape data representing a target shape of the mold from the mold actual shape data and the molded product difference data by using a trained model generated in advance by machine learning, with training mold shape data and training molded product difference data as input data and with training mold target shape data as teacher data.

### (Second Aspect)

The mold manufacturing assistance system according to the first aspect, further including a conversion unit that converts original data representing the actual shape of the mold into the mold actual shape data to be input to the trained model.

### (Third Aspect)

The mold manufacturing assistance system according to the first or second aspect, further including: a CAM unit that converts the mold target shape data into NC data; and a machine tool that corrects the actual shape of the mold based on the NC data.

### (Fourth Aspect)

The mold manufacturing assistance system according to the third aspect, further including a shape measuring instrument that measures an actual shape of a molded product molded by the mold that has been corrected by the machine tool.

### (Fifth Aspect)

The mold manufacturing assistance system according to the fourth aspect, further including a subtraction unit that calculates after-correction difference data representing a difference between the actual shape of the molded product measured by the shape measuring instrument and the target shape.

### (Sixth Aspect)

The mold manufacturing assistance system according to the fifth aspect, in which the estimation unit estimates new mold target shape data using the mold target shape data as new mold actual shape data and using the after-correction difference data as new molded product difference data.

### (Seventh Aspect)

The mold manufacturing assistance system according to any one of the first to sixth aspects, further including: a display unit that displays the mold target shape data estimated by the trained model; and a reception unit that receives decision of the target shape of the mold by a user.

### (Eighth Aspect)

The mold manufacturing assistance system according to the fifth aspect, further including a training unit that performs retraining of the trained model by using the mold target shape data estimated by the trained model and molded product actual shape data representing the actual shape of the molded product measured by the shape measuring instrument.

### (Ninth Aspect)

A mold manufacturing assistance method, including:
acquiring mold actual shape data representing an actual shape of a mold and molded product difference data representing a difference between an actual shape and a target shape of a molded product molded by the mold; and
estimating mold target shape data representing a target shape of the mold from the mold actual shape data and the molded product difference data by using a trained model generated in advance by machine learning, with training mold shape data and training molded product difference data as input data and with training mold target shape data as teacher data.

### (Tenth Aspect)

A method for generating a training dataset, including:
preparing a plurality of pieces of mold shape data and a plurality of pieces of molded product shape data corresponding to the plurality of pieces of mold shape data;
extracting first and second mold shape data from the plurality of pieces of mold shape data;
extracting first and second molded product shape data corresponding to the first and second mold shape data from the plurality of pieces of molded product shape data; and
setting the first mold shape data as training mold shape data, setting a difference between the first and second molded product shape data as training molded product difference data, and setting the second mold shape data as training mold target shape data.

### (Eleventh Aspect)

A mold manufacturing assistance system including:
an acquisition unit that acquires mold shape data representing a shape of a mold; and
an estimation unit that estimates molded product predicted shape data representing a predicted shape of a molded product from the mold shape data by using a trained model generated in advance by machine learning, with training mold shape data as input data and training molded product shape data as teacher data.

### (Twelfth Aspect)

The mold manufacturing assistance system according to the eleventh aspect, further including a display unit that displays the mold shape data and the molded product predicted shape data.

### (Thirteenth Aspect)

The mold manufacturing assistance system according to the twelfth aspect, in which the display unit further displays molded product target shape data representing a target shape of the molded product.

### (Fourteenth Aspect)

The mold manufacturing assistance system according to the twelfth or thirteenth aspect, further including:
a reception unit that receives correction of the mold shape data by a user, in which
the estimation unit estimates new molded product predicted shape data from the corrected mold shape data, and
the display unit displays the new molded product predicted shape data.

### (Fifteenth Aspect)

A mold manufacturing assistance method including:
acquiring mold shape data representing a shape of a mold; and
estimating molded product predicted shape data representing a predicted shape of a molded product from the mold shape data by using a trained model generated in advance by machine learning, with training mold shape data as input data and training molded product shape data as teacher data.

This application claims priority based on Japanese Patent Application No. 2023 054608 filed on Mar. 30, 2023. Japanese Patent Application No. 2023 054608is incorporated herein by reference.

### REFERENCE SIGNS LIST

1 assistance device
2 GUI terminal
3 CAM/machine tool
4 pressing machine
5 shape measuring instrument
6 molding analysis DB
11 acquisition unit
12 estimation unit
13 training unit
21 conversion unit
22 subtraction unit
23 reception unit
24 display unit
100 mold manufacturing assistance system

1. A mold manufacturing assistance system comprising:
an acquisition unit that acquires mold actual shape data representing an actual shape of a mold and molded product difference data representing a difference between an actual shape and a target shape of a molded product molded by the mold; and
an estimation unit that estimates mold target shape data representing a target shape of the mold from the mold actual shape data and the molded product difference data by using a trained model generated in advance by machine learning, with training mold shape data and training molded product difference data as input data and with training mold target shape data as teacher data.

2. The mold manufacturing assistance system according to claim 1, further comprising a conversion unit that converts original data representing the actual shape of the mold into the mold actual shape data to be input to the trained model.

3. The mold manufacturing assistance system according to claim 1, further comprising: a CAM unit that converts the mold target shape data into NC data; and a machine tool that corrects the actual shape of the mold based on the NC data.

4. The mold manufacturing assistance system according to claim 3, further comprising a shape measuring instrument that measures an actual shape of the molded product molded by the mold that has been corrected by the machine tool.

5. The mold manufacturing assistance system according to claim 4, further comprising a subtraction unit that calculates after-correction difference data representing a difference between the actual shape of the molded product measured by the shape measuring instrument and the target shape.

6. The mold manufacturing assistance system according to claim 5, wherein
the estimation unit estimates new mold target shape data using the mold target shape data as new mold actual shape data and using the after-correction difference data as new molded product difference data.

7. The mold manufacturing assistance system according to claim 1, further comprising: a display unit that displays the mold target shape data estimated by the trained model; and a reception unit that receives decision of the target shape of the mold by a user.

8. The mold manufacturing assistance system according to claim 5, further comprising a training unit that performs retraining of the trained model by using the mold target shape data estimated by the trained model and molded product actual shape data representing the actual shape of the molded product measured by the shape measuring instrument.

9. (canceled)

10. A method for generating a training dataset comprising;
preparing a plurality of pieces of mold shape data and a plurality of pieces of molded product shape data corresponding to the plurality of pieces of mold shape data;
extracting first and second mold shape data from the plurality of pieces of mold shape data;
extracting first and second molded product shape data corresponding to the first and second mold shape data from the plurality of pieces of molded product shape data; and
setting the first mold shape data as training mold shape data, setting a difference between the first and second molded product shape data as training molded product difference data, and setting the second mold shape data as training mold target shape data.

11. A mold manufacturing assistance system comprising:
an acquisition unit that acquires mold shape data representing a shape of a mold; and
an estimation unit that estimates molded product predicted shape data representing a predicted shape of a molded product from the mold shape data by using a trained model generated in advance by machine learning, with training mold shape data as input data and training molded product shape data as teacher data.

12. The mold manufacturing assistance system according to claim 11, further comprising a display unit that displays the mold shape data and the molded product predicted shape data.

13. The mold manufacturing assistance system according to claim 12, wherein the display unit further displays molded product target shape data representing a target shape of the molded product.

14. The mold manufacturing assistance system according to claim 12, further comprising a reception unit that receives correction of the mold shape data by a user, wherein
the estimation unit estimates new molded product predicted shape data from the corrected mold shape data, and
the display unit displays the new molded product predicted shape data.

15. (canceled)
